(19) United States
(12) Patent Application Publication
(10) Pub. No.: US 2006/0190938 A1
(43) Pub. Date: Aug. 24, 2006

(54) System and method for predictive idle-time task initiation

(76) Inventors: Peter George Capek, Ossining, NY (US); Richard Wayne Cheston, Cary, NC (US); Howard Jeffrey Locker, Cary, NC (US); Clifford Alan Pickover, Yorktown Heights, NY (US)

Correspondence Address: Whitham, Curtis, & Christofferson, P. C.;Suite 340, 11491 Sunset Hills Road, Reston, VA, 20190, US

(21) Appl. No.: 11/061,481

(22) Filed: Feb. 22, 2005

(51) Int. Cl. G06F 9/45

(52) U.S. Cl. 717/161

(57) ABSTRACT

A system automatically determines probable idle times for a computing system and performs maintenance tasks, such as virus scanning, during these times. A prediction of probable idle times is based on an assessment of a user's past use or by an aggregate of information from several users if a company wishes to determine optimal times for running such tasks or pushing software patches to employees. A policy table set by the user or a company determines the priority of maintenance tasks to be run during the predicted idle time.

### BACKGROUND OF THE INVENTION

1. Field of the Invention

The present invention generally relates to computer maintenance and, more particularly, to a system which automatically determines probable idle times for a computing system and performs maintenance tasks, such as virus scanning, during these times.

2. Background Description

Contemporary client operating systems require that certain maintenance tasks be performed periodically in order to maintain the health of the system. The term system “health” refers to the overall condition of such systems attributes as performance, security, integrity, and currency. Many maintenance tasks, such as virus scanning, backup, disk defragmentation, database compaction, adware scanning, and installation of software updates and operating system patches, render a client system difficult to use while the maintenance is taking place. Nonetheless, their mandatory nature often causes system implementers and administrators to “force” them to run at fixed times during a week. This inflexibility with respect to time places a burden on a user.

### SUMMARY OF THE INVENTION

It is therefore an object of the present invention to provide a system which automatically performs maintenance tasks in a manner that is transparent to the user, thereby minimizing the burden on the user.

It is another object of the invention to provide a system which determines when the computing system is likely to be idle and performs maintenance tasks during those times.

In order to increase user satisfaction levels while also maintaining system health, the present invention provides a method and system for applying a “predictive idle-time algorithm”. The goal of this algorithm is to observe the user's behavior and, from this, determine when maintenance tasks can be executed so as not to disturb the user. Where this can be achieved, the invention can avoid detracting from a user's ability to use his or her system, while still performing the maintenance tasks in a timely way.

This algorithm monitors the system on a continuing basis and determines for each fixed size interval in the course of a repeating period, the intervals during which the system is:
customarily turned on and in use by its user,
customarily turned on but generally not in use by its user, and
customarily turned off
   The algorithm will then use the information about the times during which the machine is generally turned on but not in use (or with little use) to perform maintenance tasks for which the user need not be present. It may also suggest to the user that he leave his machine turned on during some of the periods when he has been turning it off, to allow maintenance to take place.

A typical interval might be 15-60 minutes, and a typical “repeating period” would be a 168-hour week. Facilities would be provided to allow adjusting these for people whose use isn't consistent with these conventions.

This procedure works by monitoring aspects of the user interface, specifically the keyboard and mouse, and any other user-interaction devices which are present, and noting the periods during which they were used at any time during the interval. CPU (Central Processing Unit) usage is also a good indicator. Specifically, periods during which the machine is turned off (including hibernating and suspended) would be accounted for by noticing the last “time awake” and the time at which operation “resumed”.

For each interval, a score is kept which summarizes the proportion of time (number of samples) during which each of the three states above was observed. From this, it is a straightforward manner to find periods (possibly of multiple consecutive intervals) during which the history of usage indicates that the system is typically powered on, but not in use or has a level of CPU or I/O (Input/Output) load beneath a threshold. A best fit technique may be used; e.g., system in use 40% versus a normal 90%+time.

Interactions with the suspend and-hibernate mechanisms are possible and appropriate. This would imply that, with user authorization, the system could exit from a suspended state in order to perform maintenance tasks. Such action could be conditioned on whether the system is running on internal batteries or wall power, and perhaps on whether it is connected via a LAN (Local Area Network). Once an interval has been found which is expected to be available for running maintenance tasks (i.e., powered on, but not in use, or in use but below a threshold), then selected maintenance tasks would be run.

Thus, once one or more time intervals are determined, then certain policies can be set. For example:
1. Run defragmentation and virus scan at highest probability of idle time.
2. Run Live Update and patch downloads, at highest probability of idle time and when connected to the network.
3. If system has not run both of the above in two weeks, then pick the best idle interval within 1 hour of the system's next connection.

This type of methodology will ensure a very high level of system performance with high levels of protection from attacks but with minimal impact upon the end-user while ensuring an IT (Information Technology) organization of policy compliance or enforcement—it has been made it autonomic. A policy table can be used to determine priorities of maintenance tasks and other factors set by a user, group, organization, or company.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a simplified block diagram of a client/server system;

FIG. 2 is a block diagram of a computer on which the invention may be implemented;

FIG. 3 is a flow diagram showing the logic of the “measure system states” process according to the invention;

FIG. 4 is a flow diagram showing the logic of the processing of the database to determine idle/off times of the computer system according to the invention;

FIG. 5 is a flow diagram showing the logic of the “run maintenance tasks” process which is run during idle times once per day or policy driven; and

FIG. 6 is a flow diagram showing the logic of the “run maintenance tasks” process which is run during idle times according to the invention.

### DETAILED DESCRIPTION OF A PREFERRED EMBODIMENT OF THE INVENTION

The preferred embodiment is described in terms of a client/server system; however, those skilled in the art will recognize that the invention may be practiced on any computer system which is used interactively by a human user. Such a system could be, for example, a notebook computer which is never connected to a network but which may be periodically connected to local databases.

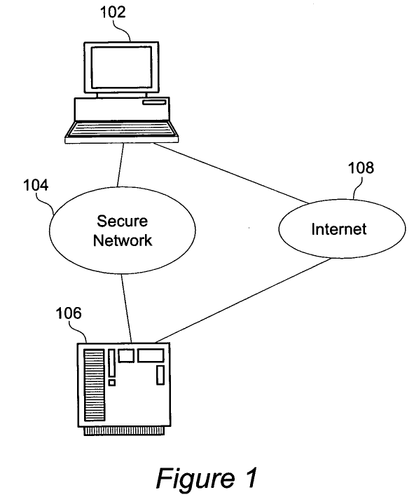

Referring now to the drawings, and more particularly to FIG. 1, there is shown, in simplified block diagram form, a client/server system on which the present invention may be implemented. A client 102, such as a personal computer (PC) is connected via a secure network 104, such as a local area network (LAN), to a server 106. Both the client 102 and the server 106 may be connected to a wide area network (WAN) or global network, such as the Internet 108. Connection to the Internet 108 may be limited to the server 106, and access to the Internet by the client 102 would then be via the server 106 through the secure network 104. In any case, the client/server system would be protected a hardware and/or software firewall (not shown).

As will become clear from the following description, the invention can be implemented at any one of the client 102, the server 106 or, in some cases, by a third party over the Internet 108. In some applications, the implementation may be a combination of two or more of these. For example, the client 102 might keep track of idle time and report the history to the server 106 which would determine the priority of and initiate the various maintenance tasks. Rather than the server 106 performing this last function, a third party service provider could perform the function. Various other implementations will suggest themselves to those skilled in the art, and a specific implementation will depend on a particular implementation and company policy.

In practice, the client/server network is much more complex than depicted in FIG. 1. Typically, there are a great many clients 102, and these may be a variety of desktop and laptop PCs, such as IBM's ThinkCentre series desk top PCs and IBM's ThinkPad series lap top PCs. Moreover, the secure network 104 may be a combination of hardwired and wireless infrastructure. Also, there are a plurality of servers 106, arranged in a server “farm” performing various functions, such as IBM's xSeries Express and BladeCenter servers. In the practice of the invention, the processes performed may be performed solely on clients 102, solely on the servers 106, or a combination of client and server operations.

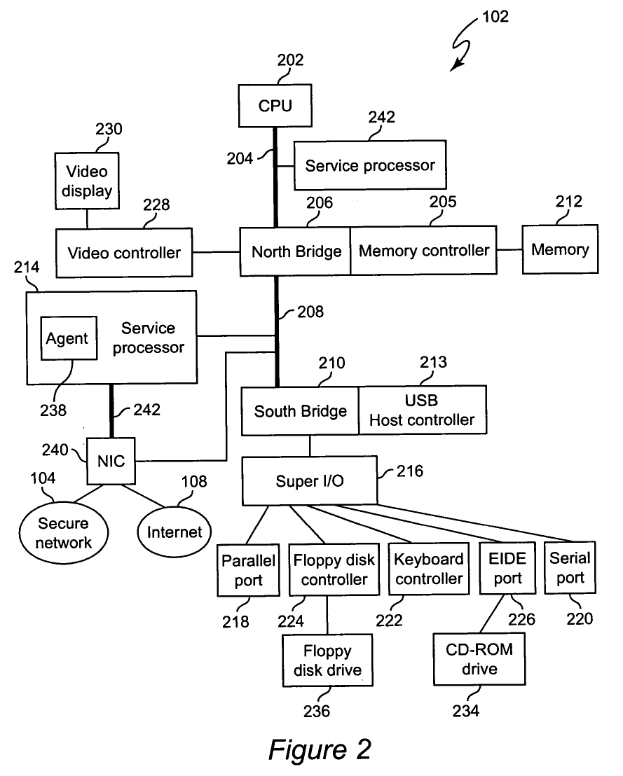

A client 102 is illustrated in more detail in the block diagram of FIG. 2. It should be noted that the architecture shown in FIG. 2 is not limited to a computer in a network but equally well illustrates a standalone computer not connected to a network. The invention can be implemented on such a standalone computer. Referring to FIG. 2, the central processing unit (CPU) 202 is supported by a chipset that includes a so-called North Bridge chip or chips 206 and a so-called South Bridge chip 210. In the North Bridge/South Bridge chipset architecture, the South Bridge 210 controls all of the computer's input/output (I/O) functions, including the basic input/output system (BIOS). All the functions of the CPU 202, except memory, PCI (Peripheral Component Interface) and AGP (Accelerated Graphics Port), are controlled by the South Bridge 210.

More particularly, the CPU 202 is connected to the North Bridge chip(s) 206 by a high speed bus 204, referred to as the front side bus (FSB), which provides the connection to the random access memory (RAM) 212, via memory controller 205, and the video controller (AGP) 228. The video controller 228 is, in turn, connected to a video display 230. The CPU 202 may be supported by a service processor 242 connected the FSB 204. The South Bridge chip 210 is connected to the North Bridge chip(s) 206 via a PCI bus 208. There may be various PCI expansion slots (not shown) connected to the PCI bus 208, depending on the specific design of the client 102. In addition to possible PCI expansion slots, a service processor 214 and a network interface card (NIC) 240 are connected to the PCI bus 208. The NIC 240 provides the connection to the secure network 104 and the Internet 108 under the control of the service processor 214 via bus 242. The service processor 214 is, in turn, controlled by a firmware agent 238.

As mentioned, the South Bridge chip 210 controls the computer's I/O functions, and these include the universal serial bus (USB) host controller 213 and, through the super I/O chip 216, various legacy I/O ports including the parallel port 218 and serial port 220, the functions of which are largely being supplanted by USB connections. In addition, the super I/O chip 216 controls other I/O devices, such as floppy disk controller 224 connected to floppy disk drive 236, keyboard controller 222, and enhanced integrated drive electronics (EIDE) port 226, to which, for example, an optical disk drive, such as a compact disk-read only memory (CD-ROM) drive 234, may be connected. Other EIDE drives (not shown), such as hard disk drives and digital versatile disk (DVD) drives may also be connected to the EIDE port 226. The super I/O chip 216 may also support the newer serial advanced technology attachment (SATA) devices. Other I/O devices may be connected to either or both the PCI bus 208 or the super I/O chip, depending on the design of the specific client 102.

The several clients in the client/server system shown in FIG. 1 will not all have precisely the same architecture. The architecture(s) of server(s) 106 is similar to that of the client 102 shown in FIG. 2 but differs primarily in the I/O functions supported. Each of the client 102 and the server 106 will have a software operating system (OS) loaded, but the operating systems will differ somewhat between client and server, again to support the functions of those computers.

The client OS requires that certain maintenance tasks be performed periodically to maintain the health of the system. For example, these tasks include running defragmentation and virus scans and running live updates and downloading and installing patches. While IT personnel might set up individual client computers so as to perform these maintenance tasks periodically at specific times, not all persons have the same schedules, and in many cases the set times interfere with a user's desire to use his or her computer. The present invention recognizes this problem and, in order to increase user satisfaction while also maintaining system health, the method and system according to the invention applies a “predictive idle-time algorithm” to perform the required maintenance functions. This algorithm observes a user's behavior and determines when maintenance tasks can most likely be executed so as not to disturb users.

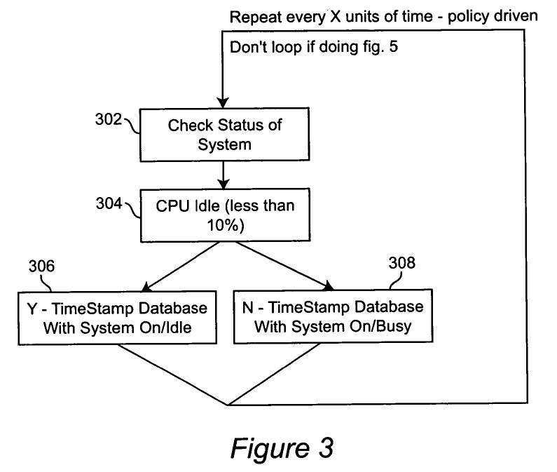

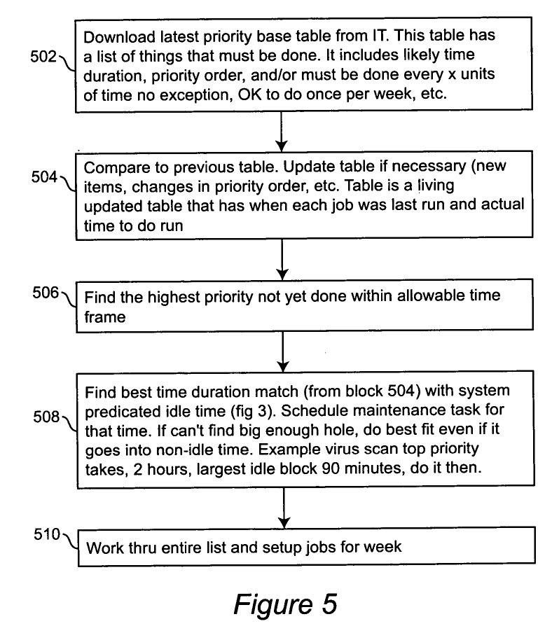

FIG. 3 shows the process of measuring system states. This is a continuous loop which begins with the function block 302 which checks the status of the system; that is, whether the system is currently processing an application or is idle. In decision block 304, a determination is made as to whether the CPU is idle. If the CPU is idle, a timestamp of system on but idle is entered in a timestamp database in function block 306. If the CPU is busy, a timestamp of system on and busy is entered in the timestamp database in function block 308. This process is repeated at periodic time periods, as determined by policy; however, the process is suspended during the time(s) when maintenance tasks are run (FIG. 5). As an alternative, a percent busy time may be stored, rather than a binary busy/idle time.

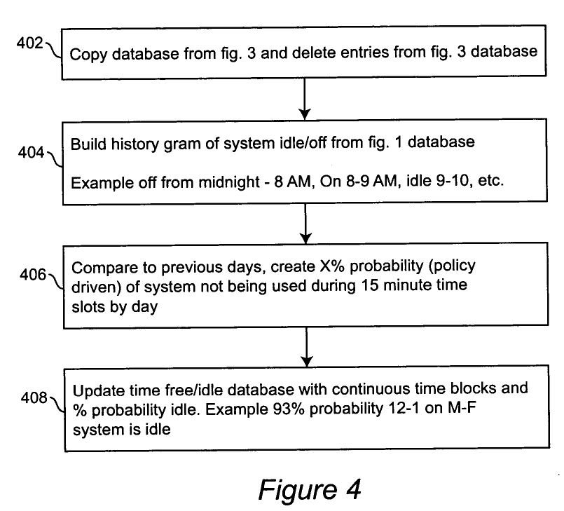

FIG. 4 shows the process which determines idle/off times. This process is done, for example, once per day or other periodic time period, as determined by policy. The process begins in function block 402 where the database generated by the process of FIG. 3 is first copied, and then the entries in the original database are deleted so that the process in FIG. 4 generates a new database and thereby effectively monitors the current actions of the user. Then, in function block 404 using the copied database, a histogram is built of system idle/off times. This histogram is compared in function block 406 to previous days to create a probability of the system not being used during time slots during a day. The user history can also include a record of any of the times a user has stopped a maintenance program and the times a user has competed with a maintenance program by trying to perform other tasks at the same time. This histogram can be displayed on, for example, an IT service console. The display could also be on the client display screen, but as a general proposition, the user will be less interested in this information than the IT service personnel. The probability is policy driven and the time periods may be, for example, 15 minute time periods, also policy driven. The definition of idle is also policy driven; e.g., below a given threshold. The user can also input times when he or she expects to be away from the client machine as, for example, travel times, vacations, and the like. These times are also used to determine times for scheduling maintenance tasks. Finally, in function block 408, the time free/idle database is updated with continuous time blocks and idle probabilities. For example, the algorithm may determine that specific client is, with a 93% probability, idle between 12:00 o'clock noon and 1:00 PM on Monday through Friday. An autocorrelation function can be applied to the history of computing resource use so that periodicities in use can be determined in order to help in the selection process of when maintenance tasks will run. Other criteria for determining computing resource use, in addition to the user's use, could be a history of a group's use and a history of a company's use.

Based on the determination of idle/off times as determined by the process of FIG. 4, the process of running maintenance tasks during idle times shown in FIG. 5 is run. The process begins in function block 502 where the latest priority base table is downloaded from a database maintained by IT personnel. This table has a list of things that must be done to maintain system health. The priority base table includes likely time duration, priority order, and/or the frequency with which tasks must be performed without exception. For example, a maintenance task may be listed as required to be done once per week. The downloaded table is compared with the previous table in function block 504 and updated if necessary. These updates may be new maintenance items, changes in priority order and the like. This table is a living, updated table that has when each maintenance job was last run and the actual time for running the maintenance job. The maintenance tasks can include the whole panoply of maintenance tasks including disk defragmentation, anti-virus scan, anti-spam scan, anti-adware scan, database compaction, downloading/applying corrective patches, encryption, application upgrades, indexing, among others. Then, in function block 506, the highest priority job not yet done within allowable time frame is found. Next, in function block 508, the best time during match from function block 504 with system predicted idle time, as determined by the process in FIG. 4, is found, and the maintenance task is scheduled for that time. If a big enough idle time cannot be found, then a best fit time is found, even if it goes into predicted non-idle time. For example, if a top priority virus scan takes two hours, but the largest predicted idle time is only ninety minutes, the virus scan is scheduled for that time event though the virus scan would run into predicted busy time, causing some minor inconvenience to the user. The process continues in function block 510 by working through the entire list and setting up maintenance jobs for the week.

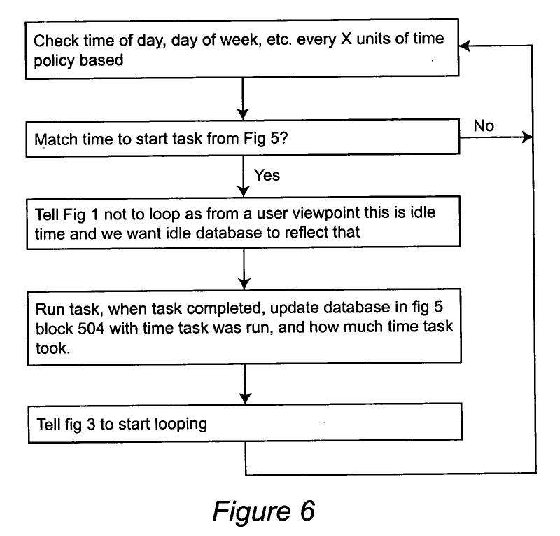

Once the schedule has been set up for the running of various maintenance jobs, the maintenance jobs are run according to the process shown in FIG. 6. The process begins in function block 602 where the time of day and day of week are checked periodically. A determination is made in decision block 604 as to whether a current time and date match a scheduled time to start a maintenance task. If not, the process loops back to function block 602; otherwise, the process of FIG. 3 is suspended in function block 606. Then, in function block 608, the scheduled maintenance task is run. When the task is completed, the database generated in FIG. 5 is updated with the time the task was run and how much time the task took. At this point in the process, the suspended process of FIG. 3 is resumed in function block 610, and the process then loops back to function block 602.

The invention avoids detracting from a user's ability to use his or her system, while still performing the required maintenance tasks in a timely way. As those skilled in the art will recognize, there are variations that can be practiced within the spirit and scope of the claimed invention. As mentioned, the process can be implemented on the client machine or the server or a combination of both. For example, some or most of the process can be done on a remote device, such as a server dedicated to the purpose, depending on how the client/server infrastructure is set up. As an example, the scheduling part (FIG. 5) could be done remotely and then sent to the client. The description of the invention assumes that the client is on, but this is not always the case. When a client is off, it is possible to for a remote device to turn it on. So, for example, a client desktop computer could be remotely controlled so that what would ordinarily be OFF time could be used as well as ON/idle time. Typically, a laptop client could only use idle time, unless the laptop is connected to a wired network. As a further variation, a user could tell the system/program that they are leaving for a certain period of time, and this time could then be considered as idle time which can be used to re-calculate schedules for maintenance tasks.

While the invention has been described in terms of a single preferred embodiment, those skilled in the art will recognize that the invention can be practiced with modification within the spirit and scope of the appended claims.

Having thus described our invention, what we claim as new and desire to secure by Letters Patent is as follows:

1. A maintenance system comprising:
maintenance task means for maintaining and improving operation of a computing system; and
automatic means for determining scheduling of the implementation of individual tasks of said maintenance means based on a history of computing resource use and a priority of said individual tasks.

2. The system of claim 1, wherein individual tasks are client management tasks.

3. The system of claim 2, wherein the client management tasks of the individual tasks includes one or more of the disk defragmentation, anti-virus scan, anti-spam scan, anti-adware scan, database compaction, downloading/applying corrective patches, encryption, application upgrades, and indexing.

4. The system of claim 1, wherein history includes a user's history of letting his or her machine be relatively idle.

5. The system of claim 4, wherein idle time is measured by one or more of a screensaver use and duration, central processing unit (CPU) level below a threshold for a given time duration, and input/output (I/O) below a threshold for a given time duration.

6. The system of claim 4, wherein idle time has an associated confidence.

7. The system of claim 1, wherein said automatic means determines scheduling based on a probability of idle time above a threshold for a given time duration.

8. The system of claim 1, wherein a history of computing resource use is determined for one or more of a history of a user's use, a history of a group's use, a history of a company's use.

9. The system of claim 1, wherein the maintenance task means is installed on a client in a client/server system.

10. The system of claim 9, wherein a server in the client/server system implements the automatic means for determining scheduling.

11. The system of claim 9, wherein said automatic means for scheduling is implemented as a service by a third party.

12. The system of claim 1, wherein said history includes a record of any of the times a user has stopped a maintenance program and the times a user has competed with a maintenance program by trying to perform other tasks at the same time.

13. The system of claim 1, wherein a history of computing resource use is presented graphically, along with maintenance tasks use.

14. The system of claim 1, wherein an autocorrelation function is applied to history of computing resource use so that periodicities in use can be determined, in order to help select when maintenance tasks will run.

15. The system of claim 1, wherein a prediction of probable idle times is based on an assessment of a user's past use or by an aggregate of information from several users if a company wishes to determine optimal times for running such tasks or pushing software patches to employees.

16. The system of claim 1, wherein the automatic means is responsive to a user input indicating when the user will be absent for a period of time.

17. A method of automatic maintenance of a computing system comprising the steps of:
measuring system busy and idle states;
processing a database to determine idle and off times;
establishing priorities for running maintenance tasks; and
running maintenance tasks during idle times according to established priorities.

18. The method of claim 17, wherein the maintenance tasks are run on a client of a client/server system.

19. The method of claim 18, wherein the database is processed on a server of the client/server system.

20. The method of claim 18, wherein the database is processed by a third party service provider.
